(19) United States
(12) Patent Application Publication
(10) Pub. No.: US 2016/0261437 A1
(43) Pub. Date: Sep. 8, 2016

(54) INTEGRATED CIRCUIT INCLUDING EQUALIZER AND METHOD FOR ADJUSTING GAIN OF EQUALIZER

(71) Applicant: SK Hynix Inc., Gyeonggi-do (KR)

(72) Inventors: Han-Kyu CHI, Gyeonggi-do (KR); Taek-Sang SONG, Gyeonggi-do (KR); Dong-Wook JANG, Gyeonggi-do (KR)

(21) Appl. No.: 14/747,890

(22) Filed: Jun. 23, 2015

(30) Foreign Application Priority Data
Mar. 6, 2015 (KR) 10-2015-0031461

(51) Int. Cl. H04L 25/03; H04L 7/00

(52) U.S. Cl. CPC H04L 25/03057; H04L 7/0025

(57) ABSTRACT

An integrated circuit is provided that includes an equalizing unit suitable for equalizing input data that is successively inputted, a sampling unit suitable for sampling centers and edges of the input data that is equalized by the equalizing unit using two or more multi-phase clocks, and a gain adjustment unit suitable for adjusting a gain of the equalizing unit using the centers of the input data and the edges of the input data that are sampled by the sampling unit.

### CROSS-REFERENCE TO RELATED APPLICATIONS

The present application claims priority of Korean Patent Application No. 10-2015-0031461, filed on Mar. 6, 2015, which is incorporated herein by reference in its entirety.

### BACKGROUND

1. Field

Exemplary embodiments of the present invention relate to an integrated circuit and, more particularly, to an equalizer.

2. Description of the Related Art

In electrical systems, a signal is transmitted within an integrated circuit (IC) chip or between two or more IC chips. Between two or more IC chips, the signal may be transmitted through a transmission line, a cable, or other means on a PCB. Within the IC chip, the signal may be transmitted through an inherent line. During the transmission, the signal experiences loss in some signal components, which should be compensated for.

During high-speed signal transmission, an equalizer or continuous time linear equalizer (CTLE) compensates for the loss. FIG. 1 is a diagram illustrating frequency responses in different examples. In FIG. 1, the reference numeral “101” Indicates the signal loss of some signal frequency components in a channel or the signal transmission line. As indicated, the signal experiences greater loss in higher signal frequency components. The reference numeral “102” indicates the frequency response characteristic of the equalizer, and the equalizer is designed to have higher gain at higher frequency. The reference numeral “103” indicates the frequency response characteristics of the signal that is recovered by the equalizer. On a channel, the loss also becomes higher as the frequency of the signal becomes higher, whereas the gain of the equalizer becomes higher as the frequency of the signal becomes higher. As a result, the signal of higher frequency is compensated by the equalizer giving the transmitted signal constant response characteristics over a wide frequency range. The high frequency signal may not be properly transferred when the gain of the equalizer is insufficient. In addition, noise components are amplified when the gain of the equalizer is excessively high.

The equalizer may be used together with a clock data recovery (CDR) circuit. In this configuration, in order to correctly control the gain of the equalizer, the phases of the clock and data, which are generated by the CDR circuit, must be correctly aligned. The quality of the received data may be poor if there is misalignment between the clock and data as well as the gain of the equalizer.

### SUMMARY

Various embodiments are directed to an integrated circuit that can properly adjust the gain of an equalizing unit.

In an embodiment, an integrated circuit includes an equalizing unit suitable for equalizing input data that is successively inputted; a sampling unit suitable for sampling centers and edges of the input data that is equalized by the equalizing unit using two or more multi-phase clocks; and a gain adjustment unit suitable for adjusting a gain of the equalizing unit using the centers of the input data and the edges of the input data that are sampled by the sampling unit.

When the sampled centers of the input data have a predetermined pattern that includes a transition point, the gain adjustment unit may adjust the gain of the equalizing unit in accordance with the sampled edges of the input data at both ends of the transition point of the sampled centers of the input data.

When the sampled centers of the input data have a pattern of (0, 0, 1, 0), the gain adjustment unit may increase the gain of the equalizing unit when the sampled edges of the input data at both ends of the transition point of the sampled centers of the input data are (0, 0), while the gain adjustment unit may decrease the gain of the equalizing unit when the sampled edges of the input data at both ends of the transition point of the sampled centers of the input data are (1, 1).

When the sampled centers of the input data have a pattern of (1, 1, 0, 1), the gain adjustment unit may increase the gain of the equalizing unit when the sampled edges of the input data at both ends of the transition point of the sampled centers of the input data are (1, 1), while the gain adjustment unit may decrease the gain of the equalizing unit when the sampled edges of the input data at both ends of the transition point of the sampled centers of the input data are (0, 0).

The equalizing unit may include a first current source suitable for supplying a predetermined amount of current to a positive output node; a second current source suitable for supplying a predetermined amount of current to a negative output node; a first sinking unit suitable for sinking the current of the positive output node in response to a voltage level of a positive input node; a second sinking unit suitable for sinking the current of the negative output node in response to a voltage level of a negative input node; a capacitor connected to the negative output node and the positive output node; and a resistor connected to the negative output node and the positive output node. The gain adjustment unit may adjust one or more of a capacitance value of the capacitor and a resistance value of the resistor.

The sampling unit may include one sampling section for each of the multi-phase clocks, and each of the sampling sections may perform sampling of the equalized input data using the clock that corresponds to the sampling section itself among the multi-phase clocks.

The gain adjustment unit may include a serial-to-parallel converter suitable for performing serial-to-parallel conversion of the sampled centers of the input data and the sampled edges of the input data; a data selector suitable for selecting and outputting the four successive sampled centers of the input data and the two successive sampled edges of the input data in the sampled centers of the input data and at the sampled edges of the input data that are serial-to-parallel converted by the serial-to-parallel converter; and a code generator suitable for generating a gain adjustment code for adjusting the gain of the equalizing unit using an output of the data selector.

The integrated circuit may further include a clock data recovery unit suitable for generating the multi-phase clocks using the sampled centers of the input data and the sampled edges of the input data.

In an embodiment, a method for adjusting a gain of an equalizer circuit includes sampling centers and edges of input data that is successively inputted; confirming whether the sampled centers of the input data have a predetermined pattern that includes a transition point; and adjusting the gain of the equalizer circuit in accordance with the sampled edges of the input data at both ends of the transition point when the sampled centers of the input data have the predetermined pattern that includes the transition point.

The predetermined pattern may be (0, 0, 1, 0), and the adjusting the gain may increase the gain of the equalizing unit when the sampled edges of the input data at both ends of the transition point are (0, 0) and may decrease the gain of the equalizing unit when the sampled edges of the input data at both ends of the transition point are (1, 1).

The predetermined pattern may be (1, 1, 0, 1), and the adjusting the gain may increase the gain of the equalizing unit when the sampled edges of the input data at both ends of the transition point are (1, 1) and may decrease the gain of the equalizing unit when the sampled edges of the input data at both ends of the transition point are (0, 0).

In an embodiment, an integrated circuit may include: an equalizing unit suitable for equalizing input data; a sampling unit suitable for sampling centers and edges of the equalized data; and a gain adjustment unit suitable for adjusting a gain of the equalizing unit using the sampled data.

The gain adjustment unit may adjust the gain when the sampled centers of the sampled data include a first part having a first value, a second part having a second value, and a third part having the first value, and the first part is transitionally stable.

The gain adjustment unit may adjust the gain based on values of single center and neighboring edges of a single duration in the sampled data.

The single center may correspond to the second part.

The gain adjustment unit may increase the gain when values between the single center and the neighboring edges are different, and the gain adjustment unit may decrease the gain when the values between the single center and the neighboring edge are the same.

The sampled centers may have a pattern of (0, 0, 1, 0).

The sampled centers may have a pattern of (1, 1, 0, 1).

The sampling unit may include one sampling sections for each of the multi-phase clocks, and each of the sampling sections may sample the equalized data using its corresponding multi-phase clock.

The integrated circuit may further include a clock data recovery unit suitable for generating the multi-phase clocks based on the sampled data.

According to embodiments of the present invention, the gain of the equalizing unit can be optimally adjusted.

### BRIEF DESCRIPTION OF THE DRAWINGS

FIG. 1 is a diagram illustrating frequency responses on a channel.

FIG. 2 is a diagram illustrating an integrated circuit in accordance with an embodiment of the present invention.

FIG. 3 is a diagram illustrating an equalizing unit shown in FIG. 2.

FIG. 4A is a diagram exemplarily illustrating a frequency gain curve of an equalizing unit in accordance with a change of a resistance value of a resistor.

FIG. 4B is a diagram exemplarily illustrating a frequency gain curve of an equalizing unit in accordance with a change of a capacitance value of a capacitor.

FIG. 5 is a diagram exemplarily illustrating a sampling unit shown in FIG. 2.

FIG. 6 is a diagram exemplarily illustrating an operation of a sampling unit shown in FIG. 5.

FIG. 7A is a diagram exemplarily illustrating a waveform of under-compensated data when an equalizing unit has insufficient gain.

FIG. 7B is a diagram exemplarily illustrating a waveform of over-compensated data when an equalizing unit has excessive gain.

FIG. 8 is a table exemplarily illustrating an operation of a gain adjustment unit shown in FIG. 2.

FIG. 9 is a diagram exemplarily illustrating a gain adjustment unit shown in FIG. 2.

FIG. 10 is a diagram exemplarily illustrating operations of a serial-to-parallel converter and a data selector shown in FIG. 9.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts in the various figures and embodiments of the present invention.

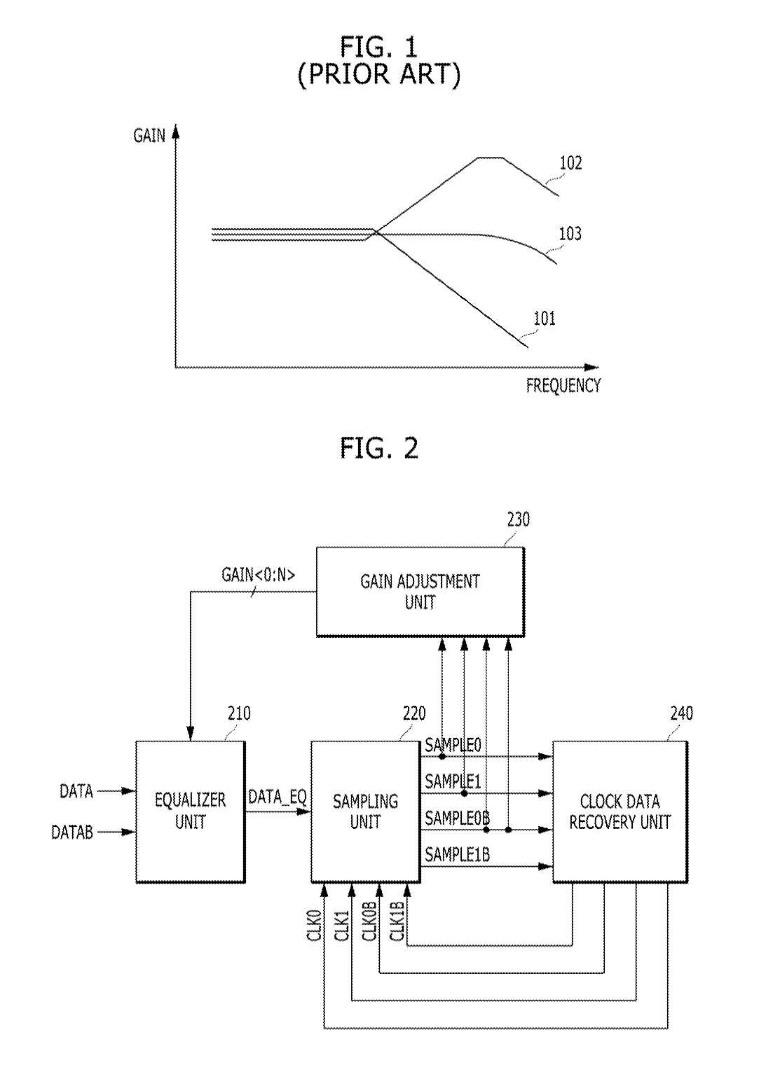

FIG. 2 is a diagram illustrating an integrated circuit in accordance with an embodiment of the present invention.

Referring to FIG. 2, an integrated circuit may include an equalizing unit 210, a sampling unit 220, a gain adjustment unit 230, and a clock data recovery unit 240.

The equalizing unit 210 may equalize data DATA and DATAB. The data DATA and DATAB may be successively inputted. Here, it is exemplified that the data DATA and DATAB is differential. The gain of the equalizing unit 210 may be adjusted by a gain adjustment code GAIN<0:N>.

The sampling unit 220 may perform sampling of centers and edges of durations of equalized data DATA_EQ that is equalized by the equalizing unit 210 using multi-phase clocks CLK0, CLK1, CLK0B, and CLK1B. For example, the sampling unit 220 may perform sampling of the centers of durations of the equalized data DATA_EQ in synchronization with the clocks CLK1 and CLK1B and may perform sampling of the edges of durations of the equalized data DATA_EQ in synchronization with the clocks CLK0 and CLK0B. Here, it is exemplified that four multi-phase clocks CLK0, CLK1, CLK0B, and CLK1B are provided. However, this is merely exemplary, and the number of multi-phase clocks is not limited thereto.

The gain adjustment unit 230 may generate the gain adjustment code GAIN<0:N> for adjusting the gain of the equalizing unit 210 using the sampling results SAMPLE0, SAMPLE1, SAMPLE0B, and SAMPLE1B of the sampling unit 220.

The clock data recovery unit 240 may generate the multi-phase clocks CLK0, CLK1, CLK0B, and CLK1B using the sampling results SAMPLE0, SAMPLE1, SAMPLE0B, and SAMPLE1B of the sampling unit 220. The clock data recovery unit 240 may sense phase differences between the data DATA and DATAB and the multi-phase clocks CLK0, CLK1, CLK0B, and CLK1B using the sampling results SAMPLE0, SAMPLE1, SAMPLE0B, and SAMPLE1B, and may adjust the phases of the multi-phase clocks CLK0, CLK1, CLK0B, and CLK1B. Accordingly, the clock data recovery unit 240 may generate the clocks CLK1 and CLK1B that are aligned with the centers of durations of the data DATA and DATAB and the clocks CLK0 and CLK0B that are aligned with the edges of durations of the data DATA and DATAB.

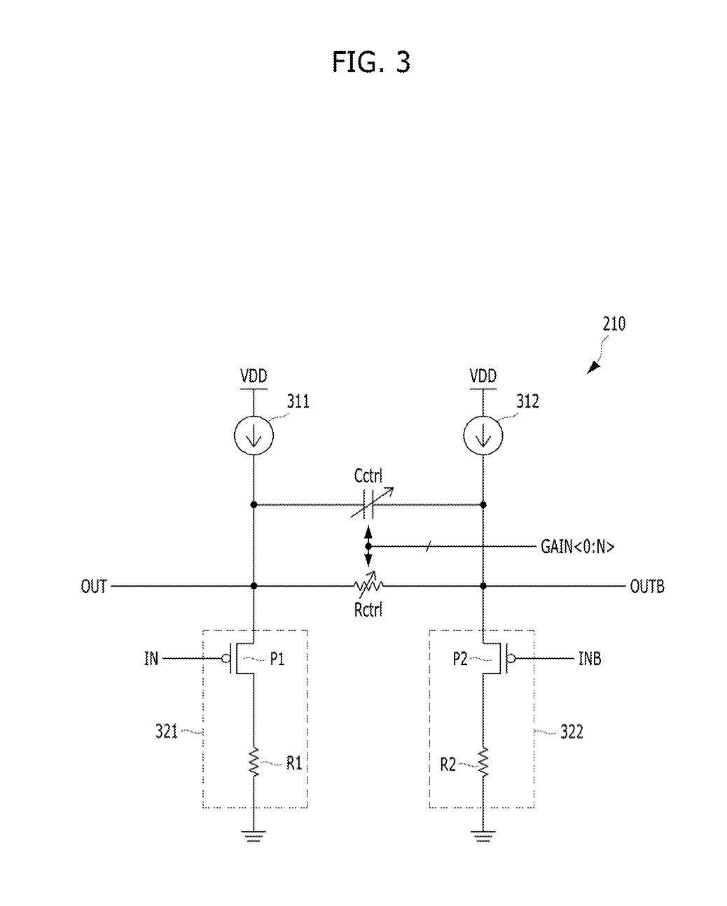

FIG. 3 is a diagram illustrating the equalizing unit 210 of FIG. 2.

Referring to FIG. 3, the equalizing unit 210 may include a first current source 311, a second current source 312, a first sinking section 321, a second sinking section 322, a capacitor Cctrl, and a resistor Rctrl.

The first and second current sources 311 and 312 may supply the same amount of current to a positive and negative output nodes OUT and OUTB, respectively.

The first sinking section 321 may sink the current of the positive output node OUT in response to a voltage level of a positive input node IN, and the second sinking section 322 may sink the current of the negative output node OUTB in response to a voltage level of a negative input node INB. The sinking sections 321 and 322 may include PMOS transistors P1 and P2 and resistors R1 and R2, respectively.

Positive data DATA may be inputted to the positive input node IN, and negative data DATAB may be inputted to the negative input node INB. Further, the equalized data DATA_EQ as an output of the equalizing unit 210 may be outputted to the positive output node OUT, and data having the opposite phase to the equalized data DATA_EQ may be outputted to the negative output node OUTB. The sampling unit 220 may use the equalized data DATA_EQ.

The positive data DATA and the negative data DATAB, which are inputted through the positive input node IN and the negative input node INB, may be outputted to the positive output node OUT and the negative output node OUTB, respectively. In this case, the frequency response characteristic, i.e., the gain of the equalizing unit 210, may be adjusted in accordance with the capacitance value of the capacitor Cctrl and the resistance value of the resistor Rctrl. The capacitor Cctrl may be a variable capacitor, the capacitance of which can be adjusted, and the resistor Rctr may be a variable resistor, the resistance of which can be adjusted.

Through adjustment of one or more of the capacitance values of the capacitor Cctrl and the resistance value of the resistor Rctrl in accordance with the gain adjustment code GAIN<0:N>, the gain of the equalizing unit 210 may be adjusted in accordance with the gain adjustment code GAIN<0:N>. That is, the equalizing unit 210 may be designed so that (1) the capacitance of the capacitor Cctrl is adjusted by the gain adjustment code GAIN<0:N>, (2) the resistance of the resistor Rctrl is adjusted by the gain adjustment code GAIN<0:N>, or (3) the capacitance of the capacitor Cctrl is adjusted by a half of the gain adjustment code GAIN<0:N> and the resistance of the resistor Rctrl is adjusted by the other half of the gain adjustment code GAIN<0:N>.

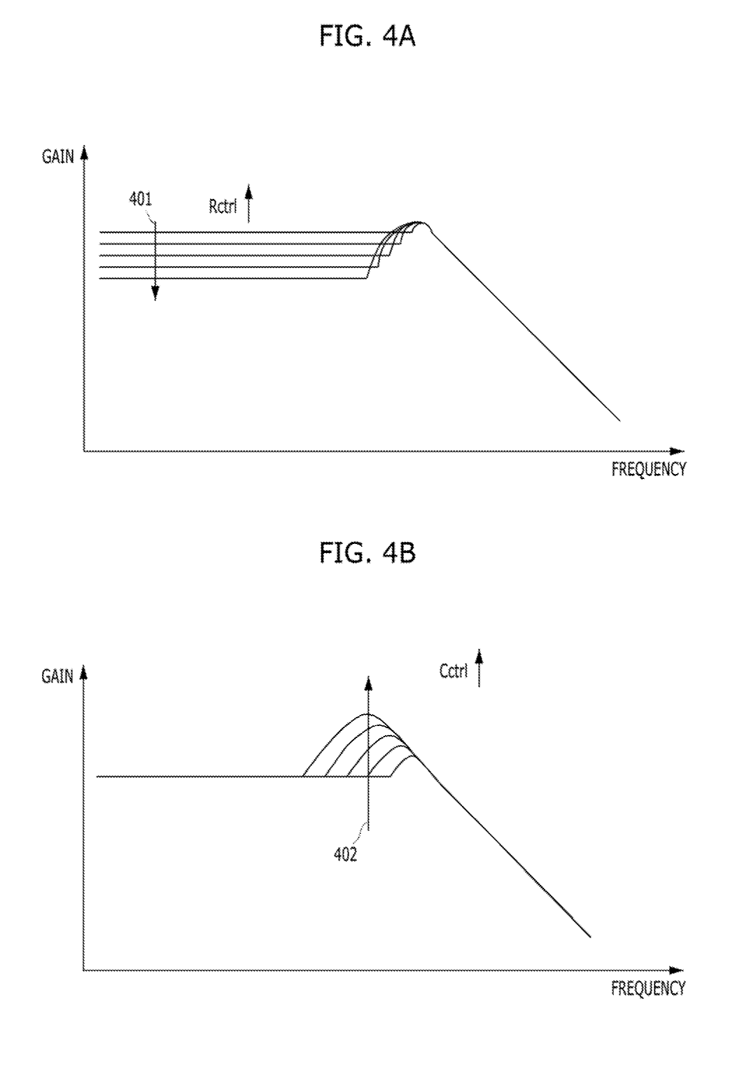

FIG. 4A is a diagram illustrating a frequency gain curve of an equalizing unit 210 in accordance with a change of the resistance value of a resistor Rctrl. Referring to FIG. 4A, as the resistance value of the resistor Rctrl is increased, the frequency gain curve moves in the direction of “401”.

FIG. 4B is a diagram illustrating a frequency gain curve of an equalizing unit 210 in accordance with a change of the capacitance value of a capacitor Cctrl. Referring to FIG. 4B, as the capacitance value of the capacitor Cctrl is increased, the frequency gain curve moves in a direction of “402”.

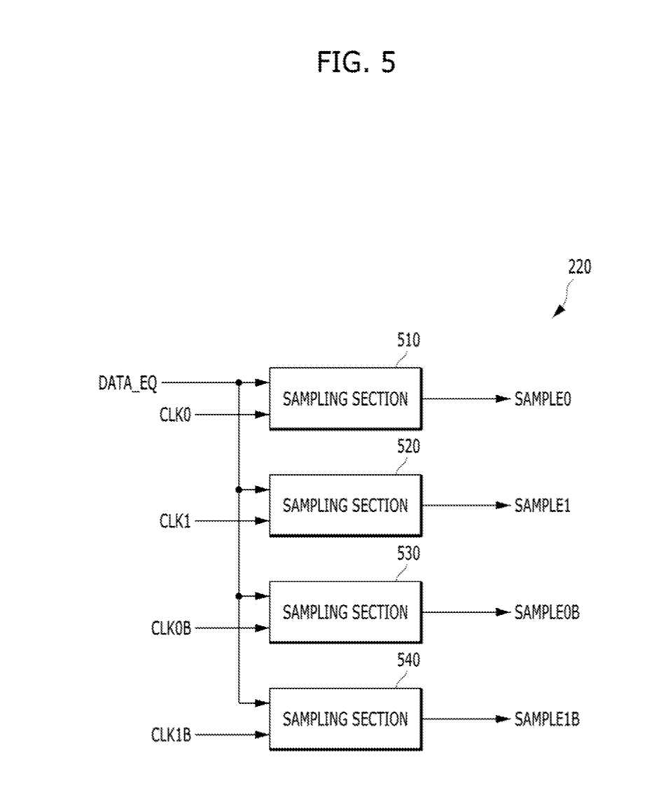

FIG. 5 is a diagram exemplarily illustrating the sampling unit 220 of FIG. 2.

Referring to FIG. 5, the sampling unit 220 may include plural sampling sections 510 to 540, the number of which is equal to the number of multi-phase clocks CLK0, CLK1, CLK0B, and CLK1B.

Each of the sampling sections 510 to 540 may perform sampling of the equalized data DATA_EQ using a corresponding one of the multi-phase clocks CLK0, CLK1, CLK0B, and CLK1B. Each of the sampling sections 510 to 540 may sample and output the equalized data DATA_EQ at a rising edge of the corresponding clock.

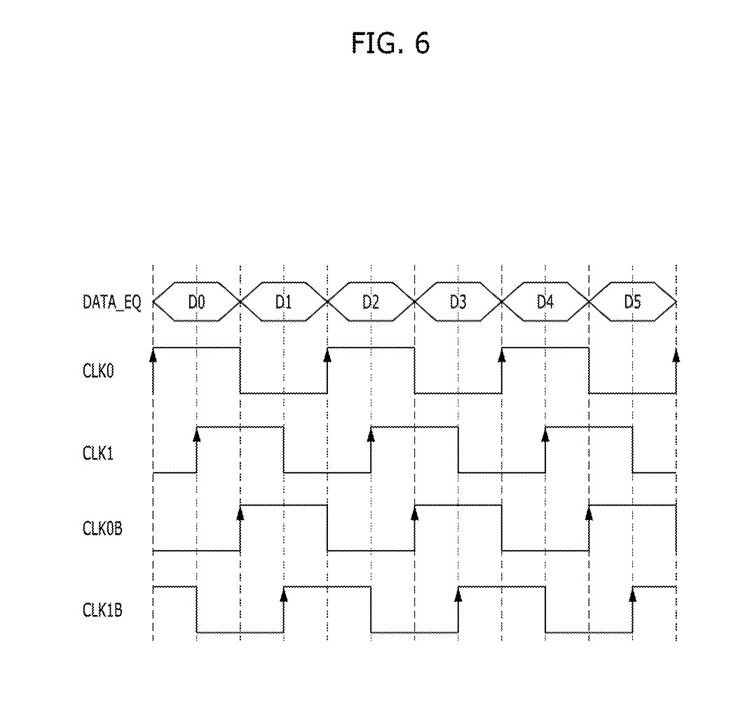

FIG. 6 is a diagram exemplarily illustrating the operation of the sampling unit 220 of FIG. 5. As described above, the sampling unit 220 may perform sampling of the centers of durations of the equalized data DATA_EQ in synchronization with the clocks CLK1 and CLK1B, and may perform sampling of the edges of durations of the equalized data DATA_EQ in synchronization with the clocks CLK0 and CLK0B. In FIG. 6, the equalized data DATA_EQ is illustrated as serial data D1 to D5. Referring to FIG. 6, the sampling unit 510 may perform sampling of a left edge of data D0, an edge between data D1 and D2, and an edge between data D3 and D4 of the equalized data DATA_EQ through the clock CLK0. Further, the sampling unit 520 may perform sampling of the centers of even-numbered data D0, D2, and D4 through the clock CLK1. Further, the sampling unit 530 may perform sampling of an edge between data D0 and D1, an edge between data D2 and D3, and an edge between data D4 and D5 through the clock CLK0B. Further, the sampling unit 540 may perform sampling of the centers of odd-numbered data D1, D3, and D5 through the clock CLK1B.

The sampling results SAMPLE0, SAMPLE1, SAMPLE0B, and SAMPLE 1B of the sampling units 510 to 540 may be transferred to the gain adjustment unit 230 and may be used to adjust the gain of the equalizing unit 210. Further, the sampling results SAMPLE0, SAMPLE1, SAMPLE0B, and SAMPLE 1B may be transferred to the clock data recovery unit 240 and may be used to determine a phase difference between the equalized data DATA_EQ and the multi-phase clocks CLK0, CLK1, CLK0B, and CLK1B.

Now, how the gain adjustment unit 230 adjusts the gain of the equalizing unit 210 and the configuration of the gain adjustment unit 230 will be described.

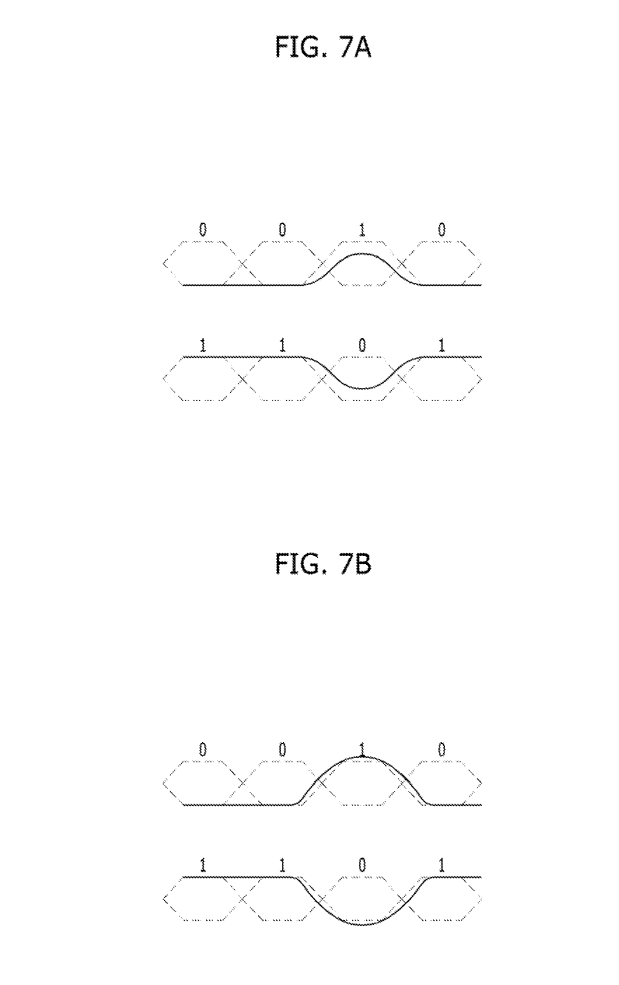

FIG. 7A is a diagram exemplarily illustrating a waveform of equalized data DATA_EQ that is under-compensated when the equalizing unit 210 has insufficient gain. Referring to FIG. 7A, the insufficient gain of the equalizing unit 210 may cause incomplete transition to “1” among the equalized data DATA_EQ (0, 0, 1, 0), and may cause incomplete transition to “0” among the equalized data DATA_EQ (1, 1, 0, 1).

FIG. 7B is a diagram exemplarily illustrating a waveform of equalized data DATA_EQ that is over-compensated when the equalizing unit 210 has excessive gain. Referring to FIG. 7B, the excessive gain of the equalizing unit 210 may cause excessive transition to “1” among the equalized data DATA_EQ (0, 0, 1, 0), and may cause excessive transition to “0” among the equalized data DATA_EQ (1, 1, 0, 1).

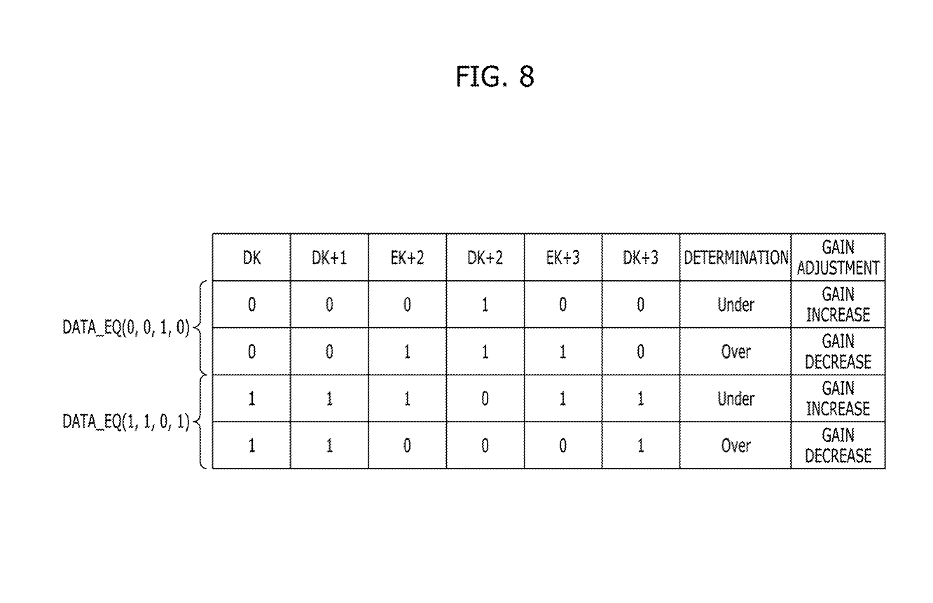

FIG. 8 is a table exemplarily illustrating the operation of the gain adjustment unit 230 of FIG. 2. In FIG. 8, nominal indications “DK, DK+1, DK+2, and DK+3” respectively indicate centers of first to fourth durations of the equalized data DATA_EQ, “EK+2” indicates a right edge of the second duration or a left edge of the third duration, and “EK+3” indicates a right edge of the third duration or a left edge of the fourth duration.

Referring to FIG. 8, when both edges at the transition point “1” of the equalized data DATA_EQ (0, 0, 1, 0) are sampled as (0, 0), which means under compensation as described with respect to FIG. 7A, the gain adjustment unit 230 may increase the gain of the higher frequency band in the frequency response characteristic of the equalizing unit 210. Further, when both edges at the transition point “1” of the equalized data DATA_EQ (0, 0, 1, 0) are sampled as (1, 1), which means over compensation as described with respect to FIG. 7B, the gain adjustment unit 230 may decrease the gain of the higher frequency band in the frequency response characteristic of the equalizing unit 210.

On the other hand, when both edges at the transition point “1” of the equalized data DATA_EQ (1, 1, 0, 1) are sampled as (1, 1), which means under compensation as described with respect to FIG. 7A, the gain adjustment unit 230 may increase the gain of the higher frequency band in the frequency response characteristic of the equalizing unit 210. Further, when both edges at the transition point “1” of the equalized data DATA_EQ (1, 1, 0, 1) are sampled as (0, 0), which means over compensation as described with respect to FIG. 7B, the gain adjustment unit 230 may decrease the gain of the higher frequency band in the frequency response characteristic of the equalizing unit 210.

The gain adjustment unit 230 may not adjust the gain of the equalizing unit 210 for the equalized data DATA_EQ having other patterns than (1, 1, 0, 1) and (0, 0, 1, 0).

In order to precisely determine the under or over compensation, data before the transition point should be in a transitionally stable state. Two or more un-transitioned and consecutive data before data transition may represent the transitionally stable state. For example, first (1, 1) of a data pattern (1, 1, 0) may represent the transitionally stable state, and first (0, 0) of a data pattern (0, 0, 1) may represent the transitionally stable state. With respect to the patterns illustrated in FIG. 8, the centers DK and DK+1 of the data, which repeat “0” twice or more, are transited to be definitely “0”, and then are transited, or the centers DK and DK+1 of the data, which repeat “1” twice or more, are transited to be definitely “1”, and then are transited. Accordingly, it is possible to determine whether the gain of the equalizing unit 210 is insufficient or excessive.

However, the determination of the under or over compensation with the equalized data DATA_EQ having other patterns than (1, 1, 0, 1) and (0, 0, 1, 0) may not be reliable. With respect to the patterns not Illustrated in FIG. 8, it is difficult to accurately determine whether the occurrence of the corresponding patterns are caused by the gain of the equalizing unit 210 or the phase difference between the multi-phase clocks CLK0, CLK1, CLK0B, and CLK1B and the equalized data DATA_EQ.

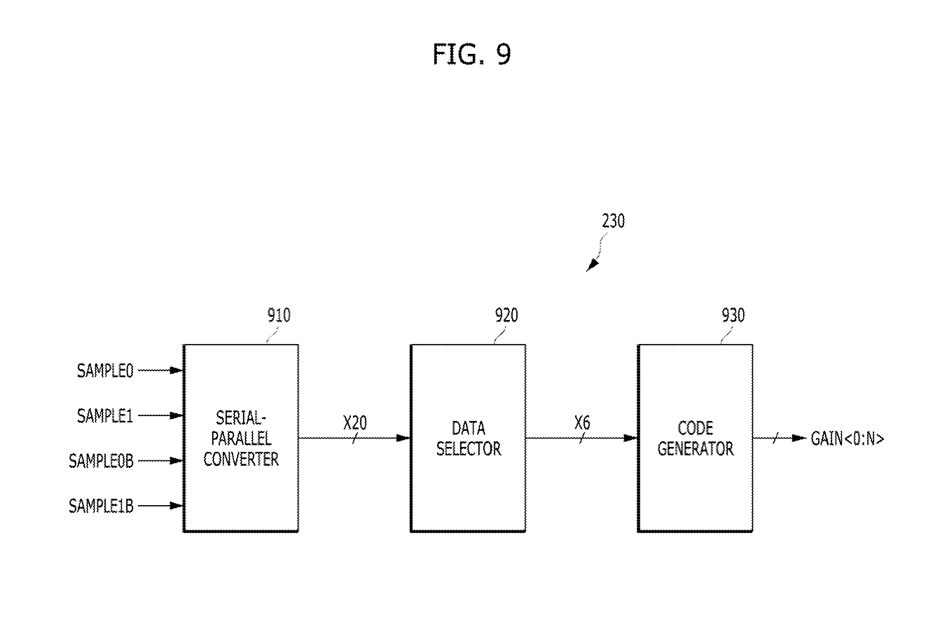

FIG. 9 is a diagram exemplarily illustrating the gain adjustment unit 230 of FIG. 2.

Referring to FIG. 9, the gain adjustment unit 230 may include a serial-to-parallel converter 910, a data selector 920, and a code generator 930.

For example, the serial-to-parallel converter 910 may perform serial-to-parallel conversion of the sampling results SAMPLE0, SAMPLE1, SAMPLE0B, and SAMPLE1B of the sampling unit 220 by 1:5. Since four sampling results SAMPLE0, SAMPLE1, SAMPLE0B, and SAMPLE1B are provided, the serial-to-parallel converter 910 may have 20 outputs.

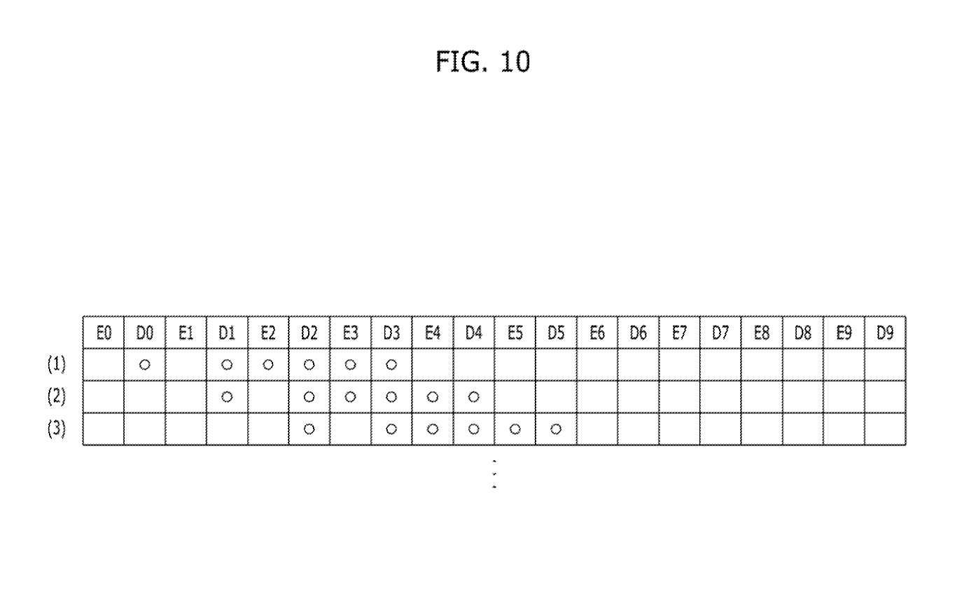

FIG. 10 is a diagram exemplarily illustrating operations of the serial-to-parallel converter 910 and the data selector 920 shown in FIG. 9.

Referring to FIG. 10, the results of serial-to-parallel conversion of 10 centers D0 to D9 and 10 edges E0 to E9 of durations of the equalized data DATA_EQ, which are performed by the serial-to-parallel converter 910.

Referring back to FIG. 9, the data selector 920 may select and output the four successive centers of the equalized data DATA_EQ and the two successive edges of the equalized data DATA_EQ among the results of serial-to-parallel conversion that is performed by the serial-to-parallel converter 910.

FIG. 10 exemplarily illustrates the selection of four centers D0, D1, D2, and D3 and two edges E2 and E3 that are selected first by the data selector 920 (“(1)” in the figure), and selection of four centers D1, D2, D3, and D4 and two edges E3 and E4 that are selected second by the data selector 920 (“(2)” in the figure).

Referring back to FIG. 9, the code generator 930 may change the value of the gain adjustment code GAIN<0:N> based on the determination of the under or over compensation of the equalized data DATA_EQ in order to increase or decrease the gain of the equalizing unit 210 through the gain adjustment code GAIN<0:N> when the selection result of the data selector 920 corresponds to one of the patterns (1, 1, 0, 1) and (0, 0, 1, 0) described with reference to FIG. 8. Further, when the selection result of the data selector 920 does not correspond to any of the patterns (1, 1, 0, 1) and (0, 0, 1, 0), the code generator 930 may maintain the current value of the gain adjustment code GAIN<0:N>.

Although various embodiments have been described for illustrative purposes, it will be apparent to those skilled in the art that various changes and modifications may be made without departing from the spirit and scope of the invention as defined in the following claims.

What is claimed is:

1. An integrated circuit comprising:
an equalizing unit suitable for equalizing input data that is successively inputted;
a sampling unit suitable for sampling centers and edges of the input data that is equalized by the equalizing unit using two or more multi-phase clocks; and
a gain adjustment unit suitable for adjusting a gain of the equalizing unit using the centers of the input data and the edges of the input data that are sampled by the sampling unit.

2. The integrated circuit of claim 1,
wherein when the sampled centers of the input data have a predetermined pattern that includes a transition point, the gain adjustment unit adjusts the gain of the equalizing unit in accordance with the sampled edges of the input data at both ends of the transition point of the sampled centers of the input data.

3. The integrated circuit of claim 1, wherein when the sampled centers of the input data have a pattern of (0, 0, 1, 0),
the gain adjustment unit increases the gain of the equalizing unit when the sampled edges of the input data at both ends of the transition point of the sampled centers of the input data are (0, 0), and
the gain adjustment unit decreases the gain of the equalizing unit when the sampled edges of the input data at the both ends of the transition point of the sampled centers of the input data are (1, 1).

4. The integrated circuit of claim 1, wherein when the sampled centers of the input data have a pattern of (1, 1, 0, 1),
the gain adjustment unit increases the gain of the equalizing unit when the sampled edges of the input data at both ends of the transition point of the sampled centers of the input data are (1, 1), and
the gain adjustment unit decreases the gain of the equalizing unit when the sampled edges of the input data at the both ends of the transition point of the sampled centers of the input data are (0, 0).

5. The integrated circuit of claim 1,
wherein the equalizing unit comprises:
a first current source suitable for supplying a predetermined amount of current to a positive output node;
a second current source suitable for supplying a predetermined amount of current to a negative output node;
a first sinking section suitable for sinking the current of the positive output node in response to a voltage level of a positive input node;
a second sinking section suitable for sinking the current of the negative output node in response to a voltage level of a negative input node;
a capacitor connected to the negative output node and the positive output node; and
a resistor connected to the negative output node and the positive output node, and
wherein the gain adjustment unit adjusts one or more of a capacitance value of the capacitor and a resistance value of the resistor.

6. The Integrated circuit of claim 1,
wherein the sampling unit comprises a sampling section for each of the multi-phase clocks, and
wherein each of the sampling sections performs sampling of the equalized input data using its corresponding clock.

7. The integrated circuit of claim 1, wherein the gain adjustment unit comprises:
a serial-to-parallel converter suitable for performing serial-to-parallel conversion of the sampled centers of the input data and the sampled edges of the input data;
a data selector suitable for selecting and outputting the four successive sampled centers of the input data and the two successive sampled edges of the input data in the sampled centers of the input data and at the sampled edges of the input data that are serial-to-parallel converted by the serial-to-parallel converter; and
a code generator suitable for generating a gain adjustment code for adjusting the gain of the equalizing unit using an output of the data selector.

8. The integrated circuit of claim 1, further comprising a clock data recovery unit suitable for generating the multi-phase clocks using the sampled centers of the input data and the sampled edges of the input data.

9. A method for adjusting a gain of an equalizer comprising:
sampling centers and edges of input data that is successively inputted;
confirming whether the sampled centers of the input data have a predetermined pattern that includes a transition point; and
adjusting the gain of the equalizer in accordance with the sampled edges of the input data at both ends of the transition point when the sampled centers of the input data have the predetermined pattern that includes the transition point.

10. The method of claim 9, wherein the predetermined pattern is (0, 0, 1, 0), and the adjusting the gain increases the gain of the equalizer when the sampled edges of the input data at both ends of the transition point are (0, 0) and decreases the gain of the equalizer when the sampled edges of the input data at both ends of the transition point are (1, 1).

11. The method of claim 9, wherein the predetermined pattern is (1, 1, 0, 1), and the adjusting the gain increases the gain of the equalizer when the sampled edges of the input data at both ends of the transition point are (1, 1) and decreases the gain of the equalizer when the sampled edges of the input data at both ends of the transition point are (0, 0).

12. An integrated circuit comprising:
an equalizing unit suitable for equalizing input data;
a sampling unit suitable for sampling centers and edges of the equalized data; and
a gain adjustment unit suitable for adjusting a gain of the equalizing unit using the sampled data.

13. The integrated circuit of claim 12,
wherein the gain adjustment unit adjusts the gain when the sampled centers of the sampled data include a first part having a first value, a second part having a second value, and a third part having the first value, and
wherein the first part is transitionally stable.

14. The integrated circuit of claim 13, wherein the gain adjustment unit adjusts the gain based on values of a single center and neighboring edges of a single duration in the sampled data.

15. The integrated circuit of claim 14, wherein the single center corresponds to the second part.

16. The integrated circuit of claim 15,
wherein the gain adjustment unit increases the gain when values between the single center and the neighboring edges are different, and
wherein the gain adjustment unit decreases the gain when the values between the single center and the neighboring edge are the same.

17. The integrated circuit of claim 13, wherein the sampled centers have a pattern of (0, 0, 1, 0).

18. The integrated circuit of claim 13, wherein the sampled centers have a pattern of (1, 1, 0, 1).

19. The integrated circuit of claim 12,
wherein the sampling unit comprises sampling sections, each having a corresponding multi-phase clock, and
wherein each of the sampling sections samples the equalized data using its corresponding multi-phase clock.

20. The integrated circuit of claim 19, further comprising a clock data recovery unit suitable for generating the multi-phase clocks based on the sampled data.
